(19) United States
(12) Patent Application Publication
(10) Pub. No.: US 2013/0092675 A1
(43) Pub. Date: Apr. 18, 2013

(54) METHOD AND APPARATUS FOR ELECTRICALLY HEATING SPRING

(71) Applicants: Yuichi Hirata, Nagoya-shi (JP); Hiroyuki Ogiso, Nagoya-shi (JP); Atsushi Fukatsu, Nagoya-shi (JP)

(72) Inventors: Yuichi Hirata, Nagoya-shi (JP); Hiroyuki Ogiso, Nagoya-shi (JP); Atsushi Fukatsu, Nagoya-shi (JP)

(73) Assignee: CHUO HATSUJO KABUSHIKI KAISHA, Nagoya-shi (JP)

(21) Appl. No.: 13/636,259

(22) PCT Filed: Mar. 15, 2011
(86) PCT No.: PCT/JP2011/056052

§ 371 Date: Jan. 2, 2013

(30) Foreign Application Priority Data
Mar. 23, 2010 (JP) 2010-065506

(51) Int. Cl. C21D 9/02; H05B 3/03

(52) U.S. Cl. CPC C21D 9/02; H05B 3/03
USPC 219/162; 219/50

(57) ABSTRACT

A method for heating an entire spring, including regions adjacent to electrodes attached thereto, in a single electrical heating process includes (i) causing at least a pair of electrodes to make contact with the spring, and then (ii) electrically heating the spring by applying a voltage across the pair of electrodes. Each of the electrodes includes a first part having a first electric resistance value and a second part having a second electric resistance value that is higher than the first electric resistance value.

### TECHNICAL FIELD

The present application relates to a technology for electrically heating a spring.

### BACKGROUND ART

A spring is treated with heat (e.g., quenching, tempering, low temperature annealing) in order to provide desired mechanical characteristics. A general thermal treatment of a spring is performed using a heating furnace, requiring a large-scale facility. Therefore, thermally treating the spring by electrically heating it is considered. When electrically heating the spring, an electrode is brought into contact with one end of the spring to be heated, and another electrode is brought into contact with the other end of the spring. Subsequently, a voltage is applied between the electrodes that are in contact with the ends of the spring, which creates a passage of electrical current from one end of the spring to the other. The spring is therefore heated by Joule heat released by the electrical current. However, it is difficult for such an electrical heating method to heat the entire spring evenly, because the electrical current does not flow smoothly in the vicinities of the sections where the electrodes come into contact with the spring. This electrical heating method used for thermally treating the spring, therefore, cannot heat the vicinities of the sections where the electrodes come into contact with the spring. Moreover, because the electrodes (copper electrodes are used generally) release heat, end parts of the spring cannot increase their temperatures and therefore cannot sufficiently be treated thermally. Consequently, desired mechanical characteristics cannot be achieved.

Japanese Patent Application Publication No. H6-136432 and Japanese Patent Application Publication No. 2004-193033, for example, propose technologies for solving the problems described above. The technologies disclosed in these patent documents bring a plurality of electrodes into contact with either end of a workpiece. When heating the workpiece, first, electrical current is caused to flow from the plurality of electrodes contacting one end of the workpiece to the plurality of electrodes contacting the other end of the workpiece, to electrically heat the entire workpiece, except for the end parts (i.e., the vicinities of the sections where the electrodes are in contact with the spring). Next, the electrical current is caused to flow between the electrodes contacting the former end of the workpiece, and the electrical current is caused to flow between the electrodes contacting the other end of the workpiece, to electrically heat only the end parts of the workpiece. As a result, the entire workpiece can be heated evenly.

### SUMMARY OF INVENTION

### Technical Problem

These technologies need to carry out a step of heating the entire workpiece (except for the sections in the vicinities of the electrodes) by causing the electrical current to flow from one end of the workpiece to the other end, and a step of heating the end parts of the workpiece by causing the electrical current to flow locally at the end parts of the workpiece. In other words, a plurality of electrical heating steps needs to be performed. The present application provides a technology capable of heating the entire workpiece including the vicinities of the electrodes, by a single electrical heating process.

### Solution to the Technical Problem

A method for electrically heating a spring, as disclosed in the present specification, comprises a step of causing at least a pair of electrodes to make contact with the spring, and a step of applying a voltage between the pair of electrodes to electrically heat the spring. Each of the electrodes comprises a first part having a first electric resistance value and a second part having a second electric resistance value higher than the first resistance value.

Each of the electrodes used in this method comprises the first part with the low electric resistance value and the second part with the high electric resistance value. Therefore, when applying electricity to the spring through the electrodes, the second part generates heat, heating the vicinities of the sections where the electrodes come into contact with the spring. The heat generated by the second part also prevents the vicinities of the electrodes on the spring from releasing heat. As a result, the entire spring including the vicinities of the electrodes can be heated by a single electrical heating process.

It is preferred that the above-described electrical heating step be executed under the condition satisfying the following formula:

α×R_{W}/(m_{W}×Cp_{W})≦R_{E}/(m_{E}×Cp_{E})

where R_{W} represents an electric resistance value of the spring, m_{W} a weight of the spring, Cp_{W} a specific heat of the spring, R_{E} an electric resistance value of the second part of each electrode, m_{E} a weight of the second part of the electrode, Cp_{E} a specific heat of the second part of the electrode, and α a coefficient determined based on a temperature of the second part of the electrode at a starting time of electricity application. Executing the electrical heating method under this condition can raise the temperature of each electrode and the temperature of a workpiece to approximately the same temperature and heat the vicinities of the electrodes of the workpiece favorably.

The coefficient α mentioned above is a coefficient taking into consideration the fact that the temperature of the second part of each electrode at the starting time of the electricity application changes in accordance with the operational status of an apparatus for electrically heating the spring in which these electrodes are used. In other words, when the apparatus is activated or intermittently operated, the increment of the temperature of the second part of each electrode needs to be increased due to the low temperature of the second part of the electrode. On the other hand, when the apparatus is operated continuously, the increment of the temperature of the second part of the electrode does not have to be increased because the temperature of the second part of the electrode is already high. Thus, by introducing the coefficient α (the coefficient α corresponding to the temperature of the second part of the electrode at the starting time of the electricity application) that changes in accordance with the operational status of the apparatus, an appropriate operating condition of the apparatus can be determined. This coefficient α may be within a range of 0.7 to 1.0. For example, when the temperature of the second part of the electrode is higher than a predetermined temperature (that is, when the apparatus is operated continuously), the coefficient α is 0.7 to 0.8. When, on the other hand, the temperature of the second part of the electrode is lower than the predetermined temperature (that is, when the apparatus is activated or intermittently operated), the coefficient α is 1.0. In this manner, the workpiece can be heated under appropriate conditions.

According to the electrical heating method described above, it is preferred that each electrode comprises the first part, the second part, and a third part, in an order from the spring side, the first part being made from a copper material, the second part being made from the same material as a material of the spring or a material having an electric resistance value equal to or higher than the electric resistance value of the spring, and the third part being made from a copper material. According to this configuration, because the first part made from the copper material is disposed in a portion coming into contact with the spring, a contact resistance between the spring and the electrode can be reduced. As a result, current can flow favorably through the spring.

The present specification provides an apparatus for electrically heating a spring, the apparatus being used favorably in the electrical heating method described above. In other words, this electrical heating apparatus disclosed in the present specification comprises a pair of electrodes configured to make contact with the spring, and a power supply configured to apply a voltage between the pair of electrodes. Each of the electrodes comprises a first part having a first electric resistance value and a second part having a second electric resistance value higher than the first electric resistance value.

### BRIEF DESCRIPTION OF DRAWINGS

FIG. 1 is a diagram showing a schematic configuration of an apparatus for electrically heating a spring according to Embodiment 1;

FIG. 2 is a diagram showing an enlargement of a configuration of an electrode;

FIG. 3 is a side view of an apparatus for electrically heating a spring according to Embodiment 2; and

FIG. 4 is a plan view of the electrical heating apparatus shown in FIG. 3.

### DESCRIPTION OF EMBODIMENTS

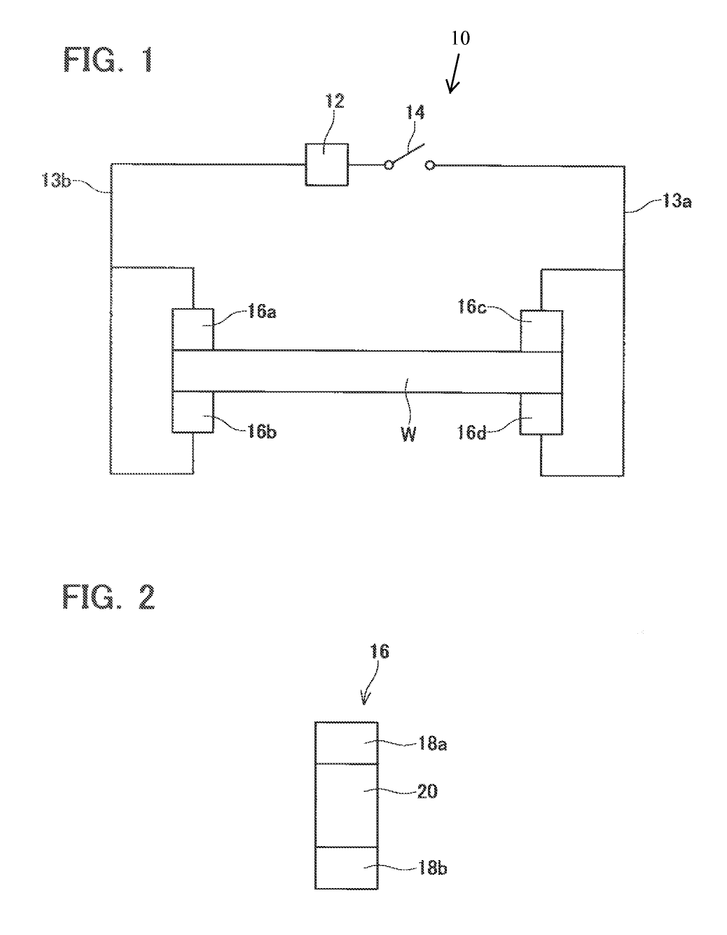

An electrical heating apparatus 10 according to an embodiment is described with reference to the diagrams. As shown in FIG. 1, the electrical heating apparatus 10 has a power supply 12, electrodes 16a, 16b connected to the power supply 12 by a wiring 13b, and electrodes 16c, 16d connected to the power supply 12 by a switch 14 and wiring 13a. A DC power supply or AC power supply can be used as the power supply 12. Switching the switch 14 ON/OFF is controlled by a controller that is not shown.

The electrodes 16a, 16b clamp one end of a workpiece W. The electrodes 16c, 16d clamp the other end of the workpiece W. The workpiece W is a torsion bar spring formed from a conductive material (e.g., spring steel). The electrodes 16a to 16d clamp the workpiece W to come into electric contact with the workpiece W. As a result, one electric circuit is formed by the power supply 12, the wirings 13a, 13b, the switch 14, the electrodes 16a to 16d, and the workpiece W. When the controller turns the switch 14 ON, current flows through the workpiece W, thereby electrically heating the workpiece W. When the controller turns the switch 14 OFF, the current flowing through the workpiece W is cutoff

The electrodes 16a to 16d have the same configuration. As shown in FIG. 2, each of the electrodes 16a to 16d is configured by a first electrode part 18a, second electrode part 20, and third electrode part 18b. The first electrode part 18a is formed from a material having a low electric resistance value (e.g., copper material (copper alloy, etc.)). A contact surface corresponding to the shape of a surface of the workpiece W is formed in the first electrode part 18a. Forming the contact surface can reduce the contact resistance between the first electrode part 18a and the workpiece W. The second electrode part 20 is formed from a material having an electric resistance value higher than that of the first electrode part 18a (e.g., an iron material). Note that when the workpiece W is a spring steel, the material of the second electrode part 20 can be an iron material having the same electric resistance value as the spring steel. When enlarging the electrodes in relation to the size of the thin workpiece, stainless steel or INCONEL having a larger electric resistance value than that of the iron material can be used. The second electrode part 20 is connected to a surface of the first electrode part 18a that does not come into contact with the workpiece W. For this reason, the second electrode part 20 does not come into direct contact with the workpiece W. The third electrode part 18b is formed from the same material as the first electrode part 18a (e.g., copper material (copper alloy)). The third electrode part 18b is connected to a surface of the second electrode part 18a that is opposite to the surface coming into contact with the first electrode part 18a.

In the present embodiment, the material, weight ratio, and size of the second electrode part 20 of each of the electrodes 16a to 16d are determined under the condition satisfying the following formula:

α×R_{W}/(m_{W}×Cp_{W})<R_{E}/(m_{E}×Cp_{E})

where R_{W} represents a resistance value of the workpiece W, m_{W} a weight of the workpiece W, Cp_{W} a specific heat of the workpiece W, R_{E} a resistance value of the second electrode part 20 of each of the electrodes 16a to 16d, m_{E} a weight of the second electrode part 20 of each electrode, Cp_{E} a specific heat of the second electrode part 20 of each electrode, and a a coefficient that changes depending on the operational status of the electrical heating apparatus 10 (i.e., a coefficient α determined based on the temperature of the second electrode part 20 of each electrode at a starting time of electricity application). Here, when the electrical heating apparatus 10 is operated continuously (e.g., when the temperature of the second electrode part 20 is higher than a predetermined temperature), the coefficient α is 0.7 to 0.8. When, on the other hand, the electrical heating apparatus 10 is activated or intermittently operated (e.g., when the temperature of the second electrode part 20 is lower than the predetermined temperature), the coefficient α is 1.0. The resistance value R_{W} of the workpiece W can be calculated from the following formula: ρ_{w×L}_{w}/A_{w} (ρ_{w}: resistivity of the workpiece W, L_{w}: a length of the workpiece W, A_{w}: a cross-sectional area of the workpiece W). Note that the resistance value R_{E} of the second electrode part 20 can be calculated in the same manner as calculating the resistance value R_{W} of the workpiece W.

By configuring the second electrode part 20 of each of the electrodes 16a to 16d so as to satisfy the condition described above, the temperature of the second electrode part 20 of each of the electrodes 16a to 16d can be increased to substantially the same temperature as that of the workpiece W when the workpiece W is electrically heated. For example, when the resistance value of the workpiece W is great and the temperature of the workpiece W tends to increase, the size and weight of the second electrode part 20 of each of the electrodes 16a to 16d are reduced, and the temperature of each of the electrodes 16a to 16d is adjusted to increase. As is clear from the above description, because the coefficient α changes depending on the operational status of the electrical heating apparatus 10, the conditions required by the second electrode part 20 also change depending on the operational status of the electrical heating apparatus 10.

When electrically heating the workpiece W by using the electrical heating apparatus 10 described above, one end of the workpiece W is clamped by the electrodes 16a, 16b, and the other end of the workpiece W is clamped by the electrodes 16c, 16d. Next, the switch 14 is turned ON to cause current to flow through the workpiece W. For instance, when using a DC power supply as the power supply 12, the current flows from one end (the electrodes 16a, 16b) of the workpiece W to the other (the electrodes 16c, 16d) or from the other end (the electrodes 16c, 16d) of the workpiece W to the former end (the electrodes 16a, 16b). The passage of the current through the workpiece W heats the entire workpiece W except for the end parts (the vicinities of the sections contacting the electrodes 16a to 16d). At the same time, each of the electrodes 16a to 16d has the second electrode part 20 with a high electric resistance value, and the temperature of each of the electrodes 16a to 16d increases to substantially the same temperature as that of the workpiece W at the time of electricity application. Thus, the heat of the electrodes 16a to 16d heats the end parts of the workpiece W (the vicinities of the sections contacting the electrodes 16a to 16d) or keeps the temperatures of these end parts. As a result, the entire workpiece W, including the terminals, are heated to a certain temperature. The switch 14 is turned OFF when ending the application of electricity to the workpiece W.

As described above, in the electrical heating apparatus 10 according to the present embodiment, each of the electrodes 16a to 16d has the second electrode part 20 with a high electric resistance value, and the temperature of each of the electrodes 16a to 16d is increased to substantially the same temperature as that of the workpiece W at the time of the electricity application. Thus, the heat of the electrodes 16a to 16d heats the end parts of the workpiece W (the vicinities of the sections contacting the electrodes 16a to 16d) or keeps the temperatures of these end parts. As a result, the entire workpiece W can be heated by a single electrical heating process (i.e., by letting a current flow from one end of the workpiece W to the other). Thermally treating the workpiece W by using the electrical heating apparatus 10 of the present embodiment (e.g., quenching, tempering, low temperature annealing) can perform a desired thermal treatment on the entire workpiece W. This can prevent the occurrence of abnormalities in the hardness or structure of the workpiece W, such as so-called delayed crack and the like, which occurs as a result of an insufficient local thermal treatment provided to the workpiece W.

Furthermore, each of the electrodes 16a to 16d has the first electrode part 18a with the low electric resistance value that is formed in a portion of each electrode that contacts the workpiece W. The contact surface corresponding to the shape of a surface of the workpiece W is formed in the first electrode part 18a. Forming the contact surface can reduce the contact resistance between the workpiece W and the first electrode part 18a, so that a current can flow through the workpiece W favorably. In some cases the second electrode part 20 is enough to reduce the contact resistance therebetween, depending on the hardness or shape of the workpiece W. In such a case, a configuration without the first electrode part 18a may be adopted.

The present embodiments are described above in detail, but these examples are merely illustrative and place no limitation on the scope of the patent claims. The technology described in the patent claims also encompasses various changes and modifications to the specific examples described above.

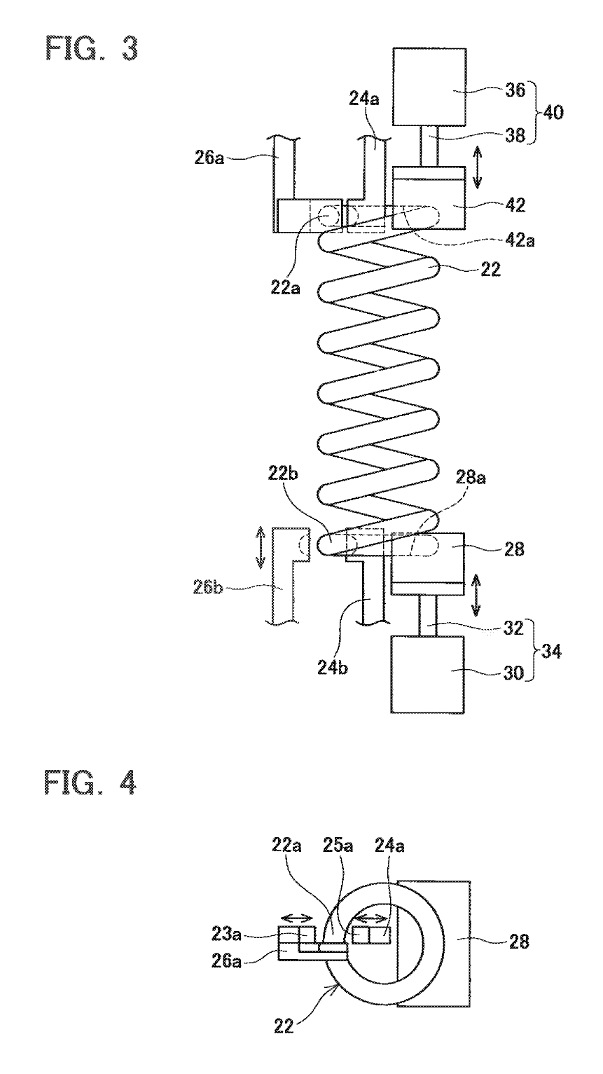

In other words, in the embodiment described above, a rod-like spring material such as a torsion bar spring (the workpiece W) is electrically heated; however, the technology disclosed in the present specification is not limited to such configuration. For instance, the technology disclosed in the present specification can be applied to an apparatus for electrically heating a coil spring 22, as shown in FIGS. 3 and 4. This electrical heating apparatus has a clamping mechanism (24a, 26a) for clamping an upper end 22a of the coil spring 22 and a clamping mechanism (24b, 26b) for clamping a lower end 22b of the coil spring 22.

The clamping mechanism (24a, 26a) has clamping members 24a, 26a. As shown in FIG. 4, electrodes 25a, 23a are attached to the clamping members 24a, 26a, respectively. Each of the electrodes 23a, 25a has the same configuration as the one described in the embodiment above. In other words, each of the electrodes 23a, 25a has a first electrode part, a second electrode part, and a third electrode part. The second electrode part has an electric resistance value higher than those of the first and third electrode parts. A contact surface corresponding to the shape of the coil spring 22 is formed in the first electrode part.

The clamping members 24a, 26a may be moved by an actuator, not shown, between a position where the clamping members 24a, 26a approach each other (clamping position) and a position where the clamping members 24a, 26a separate from each other (releasing position). When the clamping members 24a, 26a are moved to the clamping position, the upper end 22a of the coil spring 22 is clamped between the electrodes 25a, 23a. As a result, the coil spring 22 and the electrodes 25a, 23a are electrically connected to each other. When, on the other hand, the clamping members 24a, 26a are moved to the releasing position, the upper end 22a of the coil spring 22 becomes in non-contact with the electrodes 25a, 23a. It should be noted that the clamping mechanism (24a, 26a) is configured capable of rotating around an axis of the coil spring 22. For this reason, even when the coil spring 22 is deformed by being electrically heated, the clamping mechanism (24a, 26a) can deal with the deformation.

The clamping mechanism (24b, 26b) for clamping the lower end of the coil spring 22 has substantially the same configuration as the clamping mechanism (24a, 26a) described above. However, unlike the clamping mechanism (24a, 26a), the clamping mechanism (24b, 26b) may be driven by the actuator, not shown, in a vertical direction as shown in FIG. 3. Driving the clamping mechanism (24b, 26b) vertically can set and remove the coil spring 22 on and from the electrical heating apparatus. As with the clamping mechanism (24a, 26a) described above, the clamping mechanism (24b, 26b) is configured capable of moving between the clamping position and the releasing position by the actuator, not shown, and being rotated around the axis of the coil spring 22.

This electrical heating apparatus also has a jig 28 for supporting the lower end 22b of the coil spring 22 and a jig 42 for supporting the upper end 22a of the coil spring 22, as shown in FIGS. 3 and 4. A contact surface 28a corresponding to the shape of the lower end 22b of the coil spring 22 is formed in the jig 28. The jig 28 is driven vertically by a hydraulic device 34. The hydraulic device 34 has a cylinder 30 and a piston rod 32 that reciprocates with respect to the cylinder 30. The jig 28 is attached to a tip end of the piston rod 32. The jig 42 also has the same configuration as the jig 28. In other words, the jig 42 has a contact surface 42a corresponding to the shape of the upper end 22a of the coil spring 22 and is driven vertically by a hydraulic system 40 having a cylinder 36 and piston rod 38. By supporting the ends of the coil spring 22 by the jigs 28 and 42, the coil spring 22 can be placed in a desired position with a high degree of accuracy. Note that the upper end of the coil spring 22 is not necessarily supported by the jig. Thus, the jig 42 for supporting the upper end 22a of the coil spring 22 may be omitted.

When electrically heating the coil spring 22 by using the electrical heating apparatus described above, first, the clamping mechanism (24b, 26b) and the jig 28 are retracted downward. Then, the coil spring 22 is set on the jig 42 using a robot hand, not shown. In other words, the robot hand is driven until the upper end 22a of the coil spring 22 abuts on the jig 42 to position the coil spring 22 in relation to the jig 42. At the same time, the clamping mechanism (24a, 26a) clamps the upper end 22a of the coil spring 22. Subsequently, the jig 28 and the clamping mechanism (24b, 26b) move upward, and then the clamping mechanism (24b, 26b) clamps the lower end 22b of the coil spring 22. While the upper end 22a and the lower end 22b of the coil spring 22 are clamped, a voltage is applied between the upper end and the lower end of the coil spring 22 to apply electricity to the coil spring 22. As a result, the entire coil spring 22 is heated except for the end parts thereof (i.e., the vicinities of the sections contacting the electrodes). At the same time, the temperatures of the end parts of the coil spring 22 (i.e., the vicinities of the sections contacting the electrodes) are increased to substantially the same temperature as that of the coil spring 22, by the heat generated by the electrodes. Once the electrical heating process on the coil spring 22 is ended, the clamping mechanism (24b, 26b) releases the lower end 22b of the coil spring 22, and then the jig 28 and the clamping mechanism (24b, 26b) are retracted downward. Subsequently, when the robot hand, not shown, grabs the coil spring 22, the clamping mechanism (24a, 26a) releases the upper end 22a of the coil spring 22. The robot hand then conveys the coil spring 22 to the outside of the apparatus.

Note that the coil spring 22 is deformed by the heat that is generated when the coil spring 22 is electrically heated. In the present embodiment, the clamping mechanism (24b, 26b) moves in the vertical direction and the clamping mechanisms (24a, 26a), (24b, 26b) rotate around the axis of the coil spring 22 in response to the deformation of the coil spring 22. Consequently, the thermal deformation of the coil spring 22 is absorbed.

As is clear from the description above, the entire coil spring 22 may be heated by a single electrical heating process by using the electrical heating apparatus shown in FIGS. 3 and 4. During the electrical heating, the clamping mechanisms may move freely in response to the thermal deformation of the coil spring 22, preventing the action of an unnecessary external force onto the coil spring 22. Therefore, the coil spring 22 may favorably be subjected to a thermal treatment. In the electrical heating apparatus described above, the clamp mechanism (24a, 26a) clamping the upper end of the coil spring 22 may be able to move in the vertical direction.

The technology disclosed in the present specification may be favorably applied when thermally treating a spring that has a tip end that does not function as a spring. In other words, the temperature of the tip end that does not function as the spring does not have to be strictly managed for a thermal treatment. Thus, by clamping the tip end between electrodes and electrically heating the tip end, the thermal treatment temperature of the section that functions as the spring and is not clamped between electrodes can be controlled with a high degree of accuracy. Examples of such a spring include a coil spring, snap ring, stabilizer bar, torsion bar spring, and spiral spring.

In the electrical heating apparatus disclosed in the present specification, the electrode sections may be heated by a heater in advance (e.g., a resistance heater, plasma heater, induction heater), and then electrical heating may be executed on the workpiece. In this manner, the vicinities of the sections of the workpiece that are in contact with the electrode sections can be heated sufficiently.

In addition, the temperature of the workpiece may be measured using a non-contact thermometer such as a thermograph, and then the level of electrical heating may be controlled based on the measured temperature.

Further, it is to be understood that the technical elements described in the present specification and the drawings exhibit technical usefulness solely or in various combinations thereof and shall not be limited to the combinations described in the claims at the time of filing. Furthermore, the techniques illustrated in the present specification and the drawings are to achieve a plurality of objectives at the same time, whereby technical usefulness is exhibited by attaining any one of such objectives.

1. A method for electrically heating a spring, the method comprising:
causing at least a pair of electrodes to make contact with the spring; and
applying a voltage across the pair of electrodes to electrically heat the spring, wherein
each of the electrodes comprises a first part having a first electric resistance value and a second part having a second electric resistance value which is higher than the first resistance value.

2. The method as in claim 1, wherein the following formula is satisfied when the voltage is applied:
$$\frac{α \times {R}_{w}}{{m}_{w} \times {Cp}_{w}} \leq \frac{{R}_{E}}{{m}_{E} \times {Cp}_{E}}$$
wherein R_{w} represents the electric resistance value of the spring,
m_{w} represents the weight of the spring,
Cp_{w} represents the specific heat of the spring,
R_{E} represents the electric resistance value of the second part of the electrode,
m_{E} represents the weight of the second part of the electrode,
Cp_{E} represents the specific heat of the second part of the electrode, and
α represents a coefficient determined based on the temperature of the second part of the electrode at the time the voltage is initially applied.

3. The method as in claim 2, wherein the higher the temperature of the second part of the electrode at the time is the voltage is initially applied, the lower the coefficient α is.

4. The method as in claim 3, wherein
when the temperature of the second part of the electrode at the time the voltage is initially applied is equal to or higher than a predetermined temperature, the coefficient α is 0.7 to 0.8, and
when the temperature of the second part of the electrode at the time the voltage is initially applied is lower than the predetermined temperature, the coefficient α is 1.0.

5. The method as in claim 4, wherein
the electrode comprises, in an order from a spring side, the first part, the second part, and a third part,
the first part is made from a copper material,
the second part is made from the same material as the material of the spring or from a material having an electric resistance value which is equal to or higher than the electric resistance value of the spring, and
the third part is made from a copper material.

6. An apparatus for electrically heating a spring, the apparatus comprising:
a pair of electrodes configured to make contact with the spring; and
a power supply configured to apply a voltage across the pair of electrodes, wherein
each of the electrodes comprises a first part having a first electric resistance value and a second part having a second electric resistance value which is higher than the first resistance value.

7. The apparatus as in claim 6, wherein
the electrode comprises, in an order from a spring side, the first part, the second part, and a third part,
the first part is made from a copper material,
the second part is made from the same material as the material of the spring or from a material having an electric resistance value which is equal to or higher than the electric resistance value of the spring, and
the third part is made from a copper material.

8. The apparatus as in claim 7, wherein the power supply is configured to satisfy the following formula when applying the voltage:
$$\frac{α \times {R}_{w}}{{m}_{w} \times {Cp}_{w}} \leq \frac{{R}_{E}}{{m}_{E} \times {Cp}_{E}}$$
wherein R_{w} represents the electric resistance value of the spring,
m_{w} represents the weight of the spring,
Cp_{w} represents the specific heat of the spring,
R_{E} represents the electric resistance value of the second part of the electrode,
m_{E} represents the weight of the second part of the electrode,
Cp_{E} represents the specific heat of the second part of the electrode, and
α represents a coefficient determined based on the temperature of the second part of the electrode at the time the voltage is initially applied.

9. The apparatus as in claim 6, wherein the power supply is configured to satisfy the following formula when applying the voltage:
$$\frac{α \times {R}_{w}}{{m}_{w} \times {Cp}_{w}} \leq \frac{{R}_{E}}{{m}_{E} \times {Cp}_{E}}$$
wherein R_{w} represents the electric resistance value of the spring,
m_{w} represents the weight of the spring,
Cp_{w} represents the specific heat of the spring,
R_{E} represents the electric resistance value of the second part of the electrode,
m_{E} represents the weight of the second part of the electrode,
Cp_{E} represents the specific heat of the second part of the electrode, and
α represents a coefficient determined based on the temperature of the second part of the electrode at the time the voltage is initially applied.

10. The method as in claim 1, wherein
the electrode comprises, in an order from a spring side, the first part, the second part, and a third part,
the first part is made from a copper material,
the second part is made from the same material as the material of the spring or from a material having an electric resistance value which is equal to or higher than the electric resistance value of the spring, and
the third part is made from a copper material.

11. The method as in claim 2, wherein
the electrode comprises, in an order from a spring side, the first part, the second part, and a third part,
the first part is made from a copper material,
the second part is made from the same material as the material of the spring or from a material having an electric resistance value which is equal to or higher than the electric resistance value of the spring, and
the third part is made from a copper material.

12. The method as in claim 3, wherein
the electrode comprises, in an order from a spring side, the first part, the second part, and a third part,
the first part is made from a copper material,
the second part is made from the same material as the material of the spring or from a material having an electric resistance value which is equal to or higher than the electric resistance value of the spring, and
the third part is made from a copper material.
